(19) United States
(12) Patent Application Publication
(10) Pub. No.: US 2008/0102831 A1
(43) Pub. Date: May 1, 2008

(54) Method, system, network and device enabling deactivating a signalling free mode

(76) Inventor: Ivan Ore, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/907,898

(22) Filed: Oct. 18, 2007

Related U.S. Application Data
(60) Provisional application No. 60/852,408, filed on Oct. 18, 2006.

(51) Int. Cl. H04Q 7/36

(52) U.S. Cl. 455/435.1

(57) ABSTRACT

A user equipment initiates a signalling free mode after detecting a ping-pong effect of repeated changes between routing areas of two networks. The user equipment starts a timer and monitors whether a switch of networks occurs. Such a switch indicates a change of a routing area to which the user equipment is connected. When detecting such a switch, the timer is reset. If the timer expires before a network switch is detected, the user equipment deactivates a signalling free mode, and optionally sends an area update message to a network for informing the network of the actual routing area of the user equipment.

### REFERENCE TO RELATED APPLICATION

This application claims priority of U.S. Provisional Patent Application No. 60/852,408, filed on Oct. 18, 2006. The -subject matter of the earlier filed application is hereby incorporated by reference.

### FIELD

The invention relates to a method, system, network and device for deactivating a signalling free mode. Further, the invention provides a method, system, network and device for communication allowing reducing signaling load when a user equipment (UE) repeatedly switches from a first access system to a second access system and vice versa.

### BACKGROUND

System Architecture Evolution (SAE) is currently under standardization.

In current 3GPP radio access technologies a location registration procedure is mandatory every time a user equipment enters e new registration area. A Location registration request is also made, in idle mode, when the user equipment changes cell due to e.g. movement of the user equipment or due to varying signal strength. Location related signalling causes a lot of signalling load.

3GPP TR 23.882, Version 1.4.2, chapter 7.6 describes requirements for signalling free during idle mode cell reselection from Long Term Evolution (LTE) system to 2G/3G systems. During signalling free mode the UE is registered to two or more routing areas. Signalling free mode enables to suppress the disadvantages of frequent registration request or location/area updates due to e.g. a ping-pong effect, which may occur when a UE is repeatedly switching between systems or networks.

Requirements to save signalling procedures when UE changes from LTE to another 3GPP radio access system comes at expense of increasing signalling load due to paging, as the network is not aware of the location of the UE. For example, if a UE is in signalling free mode between routing areas S-RA (now also called TA, tracking area) (LTE), and RA (3G), the network will not know in which radio access the UE is currently located. It could be in LTE or in 3G. Thus, when a downlink data arrives to the network, the network will transmit paging messages in two different systems (in LTE and 3G). If signalling free is applied to three or more different routing area accesses (LTE, 3G and 2G) then the paging is sent to the three or more different systems.

Inefficient usage of resources occurs when signalling free is applied to scenarios where ping-pong effects are not present. In this case, the network is unnecessarily increasing signalling load to several radio access networks. See FIGS. 1, 2 as an example. In this example, UE moves from position A (UE in LTE) to position B (in 3G) e.g. due to radio fluctuations. Due to ping pong effect, UE will be moving between these two positions quite frequently. Thanks to signalling free in idle mode, UE will not originate unnecessary signalling to network.

### SUMMARY

An advantage of the present invention is the possibility to reduce overall signalling load, by letting UE to disable the signalling free mode when ping-pong effect is not present. This situation may occur when UE spends most of the time in point C or A (see FIGS. 1, 2). Disabling signalling free mode in this situation decreases the amount of paging needed when UE is about to have DL (down link) data.

Even more signalling saving may be achieved when several systems are included applying signalling free. Even more advantage is achieved when UE density is high.

### BRIEF DESCRIPTION OF THE DRAWINGS

FIG. 1 shows a general case of several networks to which a user equipment can register,

FIG. 2 illustrates details of change of connections of a mobile user equipment,

FIG. 3 shows a diagram of components of an embodiment of a user equipment in accordance with the invention,

FIG. 4 illustrates an embodiment of a method in accordance with the invention, and

FIG. 5 shows a signalling flow chart in accordance with an embodiment of the invention.

### DETAILED DESCRIPTION OF EMBODIMENTS OF THE INVENTION

According to at least one or more of the embodiments of the invention, a mode with reduced signaling from a user equipment to a network, such as a signalling free mode used in an idle mode of the user equipment, can be deactivated by the user equipment or the network. The at least one or all embodiments can be applied e.g. in an idle mode (e.g. of networks or systems according to long term evolution, LTE) so as to avoid or reduce an unnecessary paging load increase. The invention can be applied to networks or systems according to System Architecture Evolution, SAE, or LTE or other kinds.

FIGS. 1, 2 show a case where a user equipment 3 moves from a position A to a position B along a path requiring repeated changes of cells to be selected for routing (connection or attachment or registration), as shown by the zigzag line between positions A and B. The user equipment 3 may be a mobile or stationary terminal e.g. allowing voice, data or other type of connection to a network or other type of terminal. At position A, the user equipment 3 is registered or connected to a routing area of a network 1, e.g. LTE (S-RA). At position B, the user equipment 3 is registered or connected to a routing area (RA) of a network 2, e.g. a 3G network. As shown in FIG. 2, in the overlapping area covered by both networks 1, 2, the connection or registration of the user equipment 3 may repeatedly change between the networks 1, 2.

The target of a signalling free mode during idle mode cell reselection from LTE to 2G/3G systems is to avoid CN procedures such as Routing area update etc whenever ping-pong problems etc. forces a user equipment 3 to change between network or system 1 such as a LTE system and another network or system 2 such as a 3GPP or 2GPP network or system.

In position C of FIGS. 1, 2, it is no longer necessary to use the signalling free mode in the idle mode as the user equipment 3 is stably connected to network 2 only.

For limiting signalling due to idle mode mobility between e.g. E-UTRA (EVOLVED UMTS TERRESTIAL RADIO ACCESS) and UTRA/GSM, the SAE/LTE system provides effective means to limit mobility related signalling during inter-RAT cell-reselection in LTE_IDLE state. For example, with similar performance to that of the “Selective RA Update procedure” defined in TS 23.060. The limiting of the signalling over the air interfaces is an important issue. The limiting of the signalling for updating the tracking or routing area (routing area in case of UTRA/2G) and signalling for paging have a trade-off relationship.

The user equipment 3 registers to both the network 1 such as SAE network and the network 2 such as UMTS network separately. After that, the MOBILITY MANAGEMENT ENTITY (MME) and the SGSN may or may not be both registered to home subscriber server, HSS. The user equipment 3 preferably gets separate routing area identifier, RAI, and tracking area identifier, TAI, for 2G/3G or LTE/SAE mobility management, allocated respectively by SGSN or MME/UPE.

The user equipment 3 can memorize, in accordance with at least one of the embodiments of the invention, the routing areas and tracking areas of the network or systems where the user equipment 3 constantly moves. The “list of routing areas” may also be built via operator (via planning) or by the user equipment (e.g. an ad-hoc list).

The concept called “signalling free during idle mode” creates a problem of reaching a user equipment. In previous architectures (3G, 2G), UE is reachable in one radio access at a time.

An implementation to save signalling procedures when UE changes e.g. from LTE to another 3GPP radio access system (due to ping-pong problems) may thus lead to an increase of a signalling load due to paging, as the network is not aware of the location of the UE (it could be in one radio access or in the other). For example, if UE is in signalling free mode between routing areas S-RA (LTE) and RA (3G), the network will not know in which radio access the UE is currently located. It could be in LTE or in 3G. Thus, when a downlink data arrives to the network, the network will transmit paging messages in two different systems (in LTE and 3G). If signalling free is applied to three different routing area access (e.g. LTE, 3G and 2G) then the paging is sent to the three different systems.

Despite the paging load increase due to signalling free in idle mode, this procedure is still quite attractive as it is more relevant to avoid signalling increase between UE and core network, CN. However inefficient usage of resources occurs when signalling free is applied to scenarios where ping-pong effects are not present. In this case, the network is unnecessarily increasing signalling load to several radio access networks. Ping-pong may not occur all the time (which is the most realistic case). In FIGS. 1, 2, UE 3 in position C will not suffer from ping-pong effects. Notice that even that UE 3 is in position C, signalling free mode will still be active and paging to all the systems included in the routing area list will be generated. If UE 3 spends more of the time in point C than in points A, B, then there is not much signalling saving by signalling free. Quite the opposite, more signalling may be generated due to paging load increase in several systems. If UE density in this kind of scenarios is high, the situation gets worse.

Therefore a mechanism has been implemented in accordance with embodiments of the invention in order to avoid the usage of signalling free mode when not needed.

In accordance with embodiments of the invention, the invention proposes to allow UE to disable signalling free idle mode procedures when signalling free mode is not needed (no ping-pong problems) and enter to normal mode. Normal mode is here considered as UE being registered to only one routing area. The UE makes this decision e.g. based on parameter information which may for instance be sent via System Information (SI).

This solution is applicable to scenarios such as in FIGS. 1, 2. Signalling free mode will start once ping-pong problems are detected (points A and B). When UE 3 detects that mobility between different radio accesses 1, 2 does not occur anymore (due to ping-pong), point C, UE 3 will stop signalling free procedures. An operator is able to define via parameter configuration if UE 3 is allowed or not to deactivate signalling free procedure. If deactivation by user equipment 3 is possible, the operator can also send parameter values used internally by user equipment 3 in order to define the triggering mechanisms to deactivate the signalling free procedure. All this information may be sent to UE 3 via System Information (broadcasted by the cell). The required timer to deactivate signalling free can be provided in LTE or 2G/3G system by SI or during RAU procedures, attach procedures or any other messaging in connected mode. When UE is in idle state or mode, UE is aware of the deactivation settings. The procedures/algorithms defining the deactivation of the signalling free procedure are preferably or optional. In accordance with an embodiment of the invention, a timer is used which is set, for example, to 20 hours. If UE 3 does not detect a switching to another access network or other types of ping-pong problems during the set timer period of e.g. 20 hours, then signalling free mode can be disabled.

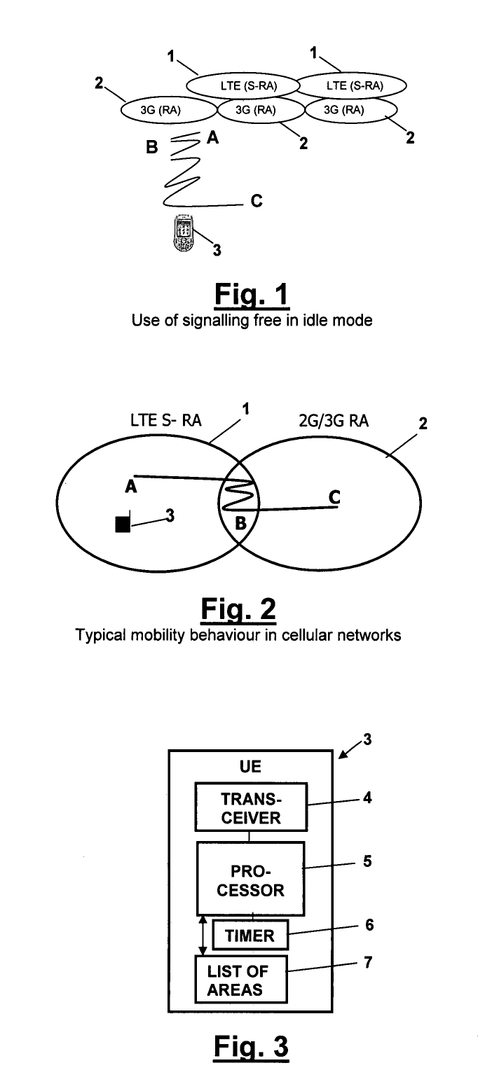

When the deactivation procedure is triggered, UE 3 clears a list 7 (shown in FIG. 3) of routing areas and keeps on memory only the routing area where is currently located. The UE 3 may start at that moment a “Routing area update” message to the core network, CN in order to inform its current routing area, or a new routing area update may be sent at the beginning of a connection request.

A different alternative can be applied from CN side, e.g., a timer can be set in CN after which signalling free can be disabled.

By limiting the use of signalling free during idle mode, the overall idea of saving signalling is accomplished. Applying signalling free in scenarios where it is not needed is a contradiction to the purposes for what this procedure was created, namely for reducing signalling load.

Unnecessary paging load across different systems can be reduced using the present invention and if UE traffic is high, radio interference in downlink is also reduced.

By letting UE 3 to enter back to normal idle mode operation, the downlink procedures simplifies (reduced delay) as signalling from user plane entity, UPE, (SAE anchor) to UE is simpler in normal idle mode than in signalling free idle mode.

The user equipment 3 optionally sends a routing area update, after deactivation of signalling free mode, in order to inform the core network, CN, on its current routing area.

In the signalling free mode the UE 3 registers to both the e.g. SAE network 1 and the e.g. UMTS network 2 separately. The Mobility Management entity, MME, and the serving GPRS support node, SGSN, may be both registered to HSS. The UE 3 gets separate routing area identifier RAI, and tracking area identifier, TAI for 2G/3G or LTE/SAE mobility management, allocated respectively by SGSN or MME/UPE (user plane entity).

Signalling free mode reduces the amount of signalling between UE and network originated by consecutive LTE and 2G/3G cell reselection events. However, the signalling saving is earned at the expenses of increasing the paging load since paging has to be sent to the two routing areas where UE has been registered: one S-RA (LTE) and one RA (2G/3G).

Due to the reason mentioned above, the signalling free procedures are deactivated when the UE's location is already stable, i.e., no inter-rat cell reselection procedures are executed anymore by UE. By deactivation of signalling free the case is described when UE stops being registered to two routing areas. The need to deactivate signalling free can be better understood by an analysis of a typical mobility behaviour between LTE and 2G/3G as shown in FIG. 2. FIG. 2 shows a typical example of mobility behaviour of a user equipment in cellular networks.

In position A, UE 3 is camped on LTE 1. When user equipment 3 moves to position B, signalling free is activated. When UE 3 reaches position C, UE's mobility is stable and located under 2G/3G routing area 2. Signalling free is not needed anymore in position C and thus a deactivation procedure for signalling free is performed.

FIG. 3 shows an embodiment of a user equipment 3 representing an embodiment in accordance with the invention. FIG. 3 illustrates only some basic components of a user equipment which otherwise may have customary structure. The user equipment 3 includes a transceiver 4 for sending and/or receiving information and messages from and to the network 1, 2 or any other device or network, and a processor 5 for controlling the user equipment 3 and storing software. Further provided are a timer 6 and a memory 7 storing a list of areas such as routing areas to which the user equipment 3 may be registered in the signalling free mode without sending area updates regarding the network to which the user equipment 3 is actually connected.

In accordance with an embodiment of the invention, a deactivation of signalling free mode is carried out upon timer expiration of timer 6 of user equipment 3 shown in FIG. 3. Deactivation of the signalling free mode reduces the impact of signalling free on the paging load as UE deactivates signalling free after a paging is sent to UE. In this implementation, the signalling free mode is deactivated after the e.g. operator's configurable timer 6 expires. In embodiments, the timer can be set to a fixed value, or can be set to different values which can be defined by the network or operator. In the latter case, the timer value may be sent to the user equipment 3 by the core network, CN, preferably during the activation of the signalling free mode. This activation may, or may not, be done when the network sends the last “ROUTING AREA UPDATE” message.

Since this timer is not yet supported in 3GPP release 6, it is preferred but not mandatory to provide the timer value always via LTE system. Since the LTE system may not be the last system before signalling free mode is activated this means that the timer value does not necessarily have to be sent on the last RAU but on the or a previous RAU in LTE. However, the timer 6 will be effective once signalling free mode starts.

In this RAU message the network optionally also informs the user equipment 3 which Routing Areas the user equipment 3 is allowed to move during idle mode without any signalling. The routing areas included in this message are then stored in the memory 7. When the user equipment 3 registers to another network due to movement, signal strength fading or any other reason such as services required etc., the processor 5 or other component of the user equipment 3 checks whether the new routing area is stored in the memory 7 and, if so, the processor 5 suppresses the sending of a routing update or other message to the network.

Inside a message sent from the network to the user equipment 3, such as the last message sent from the network to the user equipment 3 before entering the signalling free mode, e.g. the last “ROUTING AREA UPDATE” message, the core network, CN, can include the timer value. The user equipment 3 extracts the received timer value from the message and sets it to the timer 6 shown in FIG. 3. The timer value may be set to e.g. 20 hours or to a value between 1 to 40 hours or 10 to 30 hours or to any other appropriate value.

The timer value to be set in timer 6 can e.g. also be broadcasted via system information, SI, in LTE. There is no need to broadcast the timer value in 2G/3G systems so that the timer value may be broadcasted in LTE only. The timer value can further be sent to the user equipment 3 for example in attachment procedures, RAU procedures or via system information, SI.

The timer control requirement is added to CN. Preferably, only LTE network, meaning MME includes this timer control of the timer value to be set to UE via RAU update etc. Alternatively, the timer control such as setting of the timer value can be implemented only in UE. The timer value should be under the control of the operator.

The timer 6 is kept by the user equipment 3 and is reset whenever the user equipment 3 does a cell reselection such as an inter-RAT cell reselection. If the timer 6 expires, it is a sign that the UE's mobility is stabilized. In this case, the user equipment 3 and/or it core network will deactivate the signalling free mode. This can e.g. be done by the user equipment 3 initiating a routing area update, RAU, procedure immediately after the expiration of the timer to let the core network know the end of signalling free mode. One more signalling step may be still acceptable compared to the significant signalling saving that signalling free mode provides. Alternatively, the signalling free mode can be deactivated once a mobile originated call or mobile terminated call (MOC/MTC call) arrives after the timer T expires. When deactivating the signalling free mode, a routing area update is optionally initiated by the user equipment 3 to enter to a “normal mode”.

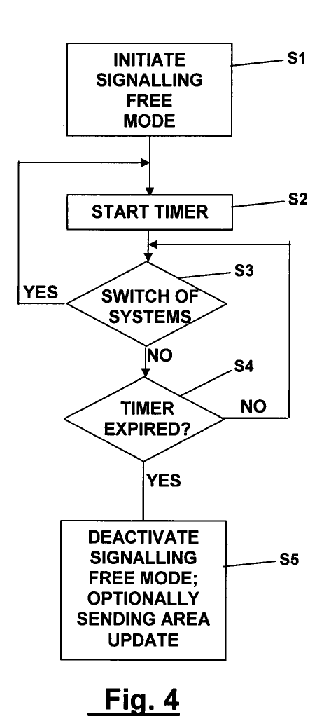

FIG. 4 shows a flow chart in accordance with an embodiment of the invention.

In a step S1, the signalling free mode is initiated or activated, e.g. after detecting a ping-pong effect of repeated changes between the same routing areas of two networks. In a step S2, the processor 5 or another component of the user equipment 3 starts the timer 6 which has been set to a timer value which timer value may be fixedly stored or may have been received within the last routing update message received from the network before step S1. In a step S3, the user equipment 3 monitors whether a switch of systems or networks occurs. Such a switch indicates a change of the routing area to which the user equipment 3 is connected, attached or registered. When detecting such a switch or change, the timer 6 is reset or restarted, as shown by the branch Yes of step S3, looping back to step S2 so as to restart the timer 6. When the answer of step S3 is NO, the process checks, in step S4, whether or not the timer 6 has expired. If not, the program loops back to step S3 so as to continuously monitor whether or not a switch of the system occurs. When detecting, in step S4, that the timer 6 has expired, a step S5 is carried out in which the signalling free mode deactivated. Optionally an area update message such as a routing area update message can be sent from the user equipment 3 to the network for informing the network on the actual routing area of the user equipment 3.

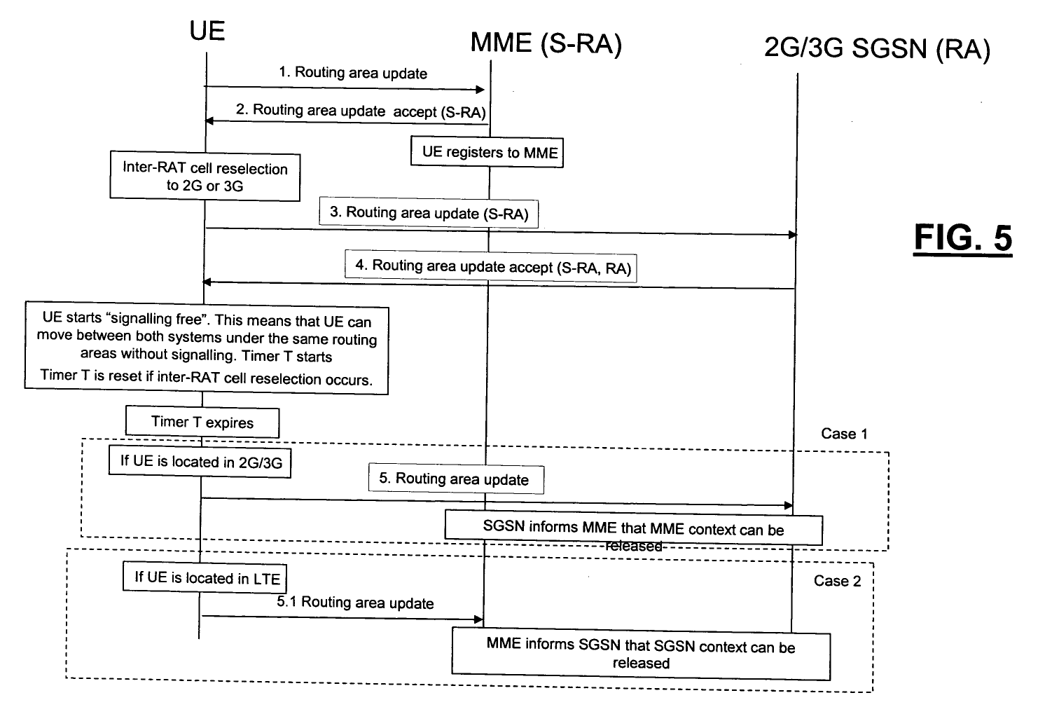

FIG. 5 shows an example of signalling free mode and deactivation thereof using timer 6. FIG. 5 illustrates a signalling flow chart of the signalling between a user equipment such as user equipment 3, a Mobility Management entity, MME and its associated routing area S-RA, and a serving GPRS support node SGSN and its associated routing area RA. The SGSN may be of the second (2G) or third generation (3G) type.

As shown in FIG. 5, the user equipment 3 sends a routing area update message 1. to the MME which returns a routing area update accept (S-RA) message 2. The UE 3 registers to MME.

Then an inter-RAT cell reselection to 2G or 3G takes place. The user equipment 3 sends a routing area update (S-RA) message 3 to the SGSN which returns a routing area update accept (S-RA, RA) message 4.

UE starts the “signalling free” mode. This means that UE can move between both systems such as MME, SGSN under the same routing areas without signalling. Timer T corresponding to timer 6 of FIG. 3 starts. The timer T is reset if inter-RAT cell reselection occurs.

When the timer T expires, two cases 1, 2 can be given. If UE is located in 2G/3G system or network (case 1), the user equipment 3 sends a routing area update to the SGSN. Thus, SGSN and the core network are informed that the user equipment is camped at the SGSN network. Further, the SGSN informs MME that MME context can be released.

If UE is located in LTE (case 2), the user equipment sends a routing area update message 5.1 to the MME. The MME informs SGSN that SGSN context can be released.

1. A method comprising:
starting a timer when entering a first mode;
registering at least two routing areas during the first mode; and
cancelling at least one of the routing areas from a routing area list upon expiration of the timer.

2. The method of claim 1, further comprising:
resetting the timer when switching from a first network to a second network.

3. The method of claim 2, further comprising:
configuring at least one of the first network and second network to comprise an access network, a radio access network, a long term evolution (LTE) network, or a 2G/3G system.

4. The method of claim 1, further comprising:
configuring the first mode to comprise a signalling free mode.

5. The method of claim 1, further comprising: sending a routing area update message to a network.

6. The method of claim 5, further comprising:
sending the routing area update to the network to indicate that the first mode is deactivated.

7. The method of claim 5, further comprising:
disabling routing area updates with the first mode when changing the network.

8. The method of claim 1, further comprising:
sending a message to a second network via a first network for informing the second network that a routing area or context can be released.

9. The method of claim 1, further comprising: receiving a value for a timer during the activation of the first mode.

10. The method of claim 9, further comprising: defining the value for a timer with an operator.

11. The method of claim 9, further comprising: broadcasting the value for the timer via system information.

12. The method of claim 1, further comprising:
activating the first mode when receiving a routing area update message.

13. The method of claim 1, further comprising:
deactivating the first mode when the timer expires.

14. The method of claim 1, wherein the canceling of the first mode is denied by an operator.

15. An apparatus configured to start a timer upon entering a first mode, the apparatus further configured to operate in the first mode in which the apparatus is configured to change attachment to another network without sending area updates.

16. The apparatus according to claim 15 wherein the apparatus is further configured to delete one or more routing areas from a routing area list upon expiration of the timer.

17. The apparatus according to claim 15 wherein the apparatus comprises a user equipment, a network element, a chipset, or a module.

18. The apparatus of claim 15, wherein the apparatus is further configured to receive a timer value from a core network during an activation of the first mode for defining a time period in which a user equipment is allowed to stay in the first mode.

19. The apparatus of claim 15, wherein the apparatus is further configured to reset the timer when switching from a first network to a second network, for starting the time period.

20. The apparatus of claim 15, wherein the apparatus is further configured to store a routing area list.

21. The apparatus of claim 15, wherein the apparatus is further configured to send a routing area update upon expiration of the timer to indicate that the first mode is deactivated.

22. A computer program embodied on a computer readable medium, the computer program configured to control a processor to perform:
starting a timer when entering a first mode;
registering at least two routing areas during the first mode; and
cancelling at least one of the routing areas from a routing area list upon expiration of the timer.

23. A network element configured to send a timer value to a user equipment in response to an area update message.

24. The network element of claim 23, wherein the timer value is controllable by a network operator.

25. The network element of claim 23, wherein the network element comprises a serving general packet radio service support node, a mobility management entity, or a user plane entity.
